(19) United States
(12) Patent Application Publication
(10) Pub. No.: US 2026/0194401 A1
(43) Pub. Date: Jul. 9, 2026

(54) IDENTIFICATION DEVICE, IDENTIFICATION METHOD, AND NON-TRANSITORY COMPUTER-READABLE MEDIUM

(71) Applicant: NEC Corporation, Tokyo (JP)

(72) Inventors: Maho TSUKAMOTO, Tokyo (JP); Koji Mizuguchi, Tokyo (JP)

(73) Assignee: NEC Corporation, Tokyo (JP)

(21) Appl. No.: 19/428,513

(22) Filed: Dec. 22, 2025

(30) Foreign Application Priority Data
Jan. 6, 2025 (JP) 2025-000057

(51) Int. Cl. G01K 11/32; G01L 1/24

(52) U.S. Cl. CPC G01K 11/32; G01L 1/242

(57) ABSTRACT

An identification device according to the present disclosure includes: at least one memory storing instructions; and at least one processor that executes the instructions to: receive backscattered light from an optical fiber included in a floating cable; detect distortions at each of positions on the cable and detect temperatures at each of the positions on the cable based on the backscattered light; and identify a floating status of the cable based on at least one of values of the distortions at each of the positions on the cable and values of the temperatures at each of the positions on the cable.

### INCORPORATION BY REFERENCE

This application is based upon and claims the benefit of priority from Japanese patent application No. 2025-000057, filed on January 6, 2025, the disclosure of which is incorporated herein in its entirety by reference.

### TECHNICAL FIELD

The present disclosure relates to an identification device, an identification method, and a non-transitory computer-readable medium.

### BACKGROUND ART

In recent years, there is a technology for monitoring a status of a target to be monitored by executing optical fiber sensing using an optical fiber.

For example, JP 2020-508464 A discloses a technology for monitoring a burial status of a subsea cable by executing optical fiber sensing using an optical fiber forming part of the subsea cable buried in the seabed.

### SUMMARY

Meanwhile, in offshore wind power generation, types of offshore wind turbines include a bottom-mounted wind turbine and a floating wind turbine. Further, floating offshore facilities include a floating offshore substation, and the like, as well as the floating wind turbine.

In a case where floating facilities are used in offshore wind power generation, dynamic cables are used for connection between the floating facilities, and subsea cables and dynamic cables are used for connection between land-based facilities and the floating facilities. The dynamic cables are cables that float in the water and dynamically follow the movement, waves, and currents of the floating facilities.

Therefore, in the case of using the floating facilities in offshore wind power generation, it is necessary to monitor not only the status of the subsea cables but also the status of the dynamic cables.

However, since the dynamic cables float in the water and dynamically follow the movement of the floating facilities or the like, the dynamic cables repeatedly undergo twisting, tension, bending, or the like, and thus behave differently from the subsea cables buried in the seabed.

Thus, the technology disclosed in JP 2020-508464 A for monitoring the status of the subsea cable has a problem that it is difficult to monitor the status of the dynamic cable having a behavior different from that of the subsea cable.

In view of the above-described problem, an example object of the present disclosure is to provide an identification device, an identification method, and a non-transitory computer-readable medium capable of monitoring a status of a floating cable.

An identification device according to an example aspect includes:

at least one memory storing instructions; and

at least one processor configured to execute the instructions to:

receive backscattered light from an optical fiber included in a cable floating in the water;

detect distortions at each of positions on the cable and detect temperatures at each of the positions on the cable based on the backscattered light; and

identify a floating status of the cable based on at least one of values of the distortions at each of the positions on the cable and values of the temperatures at each of the positions on the cable.

An identification method according to an example aspect is an identification method executed by an identification device, the identification method includes:

receiving backscattered light from an optical fiber included in a cable floating in the water;

detecting distortions at each of positions on the cable and detecting temperatures at each of the positions on the cable based on the backscattered light; and

identifying a floating status of the cable based on at least one of values of the distortions at each of the positions on the cable and values of the temperatures at each of the positions on the cable.

A non-transitory computer-readable medium according to an example aspect stores a program for causing a computer to execute:

a procedure of receiving backscattered light from an optical fiber included in a cable floating in the water;

a procedure of detecting distortions at each of positions on the cable and detecting temperatures at each of the positions on the cable based on the backscattered light; and

a procedure of identifying a floating status of the cable based on at least one of values of the distortions at each of the positions on the cable and values of the temperatures at each of the positions on the cable.

According to the example aspects described above, it is possible to provide an identification device, an identification method, and a non-transitory computer-readable medium capable of monitoring a status of a floating cable.

### BRIEF DESCRIPTION OF DRAWINGS

The above and other aspects, features and advantages of the present disclosure will become more apparent from the following description of certain exemplary embodiments, taken in conjunction with the accompanying drawings, in which:

FIG. 1 is a diagram for explaining a schematic laying example of a dynamic cable;

FIG. 2 is a diagram illustrating a schematic configuration example of an

identification device according to the present disclosure;

FIG. 3 is a diagram for explaining a specific example of an operation of an analysis unit according to the present disclosure;

FIG. 4 is a diagram for explaining a specific example of the operation of the analysis unit according to the present disclosure;

FIG. 5 is a flowchart for explaining an example of a schematic operation flow of the identification device according to the present disclosure;

FIG. 6 is a diagram illustrating a schematic configuration example of the identification device according to the present disclosure;

FIG. 7 is a diagram for explaining a specific example of the operation of the analysis unit according to the present disclosure;

FIG. 8 is a diagram for explaining a specific example of the operation of the analysis unit according to the present disclosure;

FIG. 9 is a diagram illustrating a schematic configuration example of the identification device according to the present disclosure; and

FIG. 10 is a block diagram illustrating a schematic hardware configuration example of a computer that implements the identification device according to the present disclosure.

### EXAMPLE EMBODIMENT

Hereinafter, example embodiments of the present disclosure will be described below with reference to the drawings. The following description and drawings will be omitted or simplified as appropriate to clarify description. In the following drawings, the same elements are denoted by the same reference signs, and redundant description will be omitted as necessary.

### Laying Example of Dynamic Cable

Before describing each of the example embodiments of the present disclosure, a laying example of a dynamic cable 20 to be monitored in the present disclosure will be described.

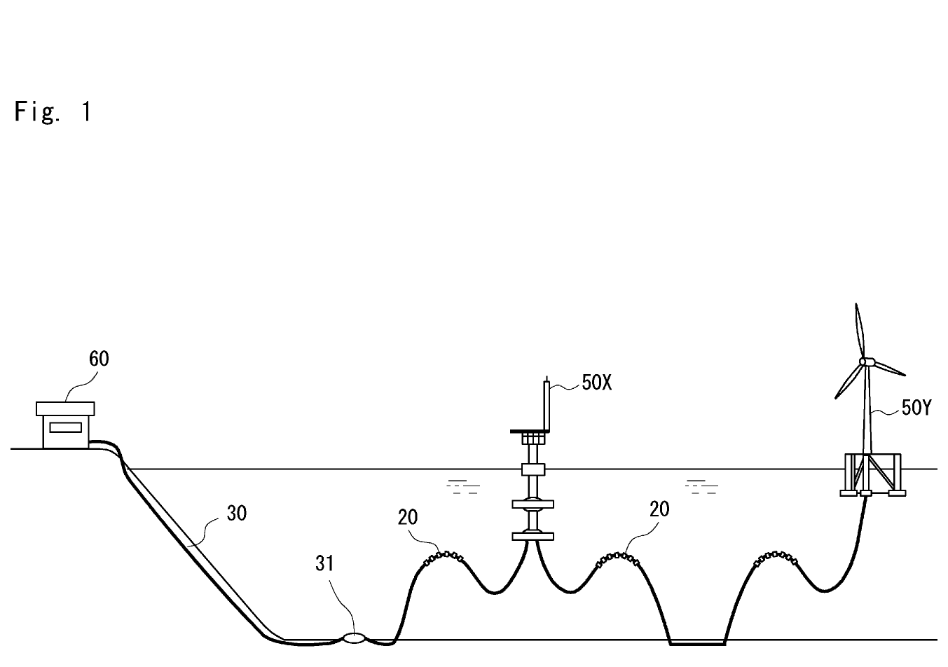

FIG. 1 is a diagram for explaining a schematic laying example of a dynamic cable 20. In this regard, FIG. 1 is an example of using the dynamic cable 20 for offshore wind power generation.

As illustrated in FIG. 1, in the offshore wind power generation, floating facilities such as a floating offshore substation 50X and a floating wind turbine 50Y are provided on the sea, for example. Hereinafter, in a case where the floating offshore substation 50X and the floating wind turbine 50Y are not identified, they are appropriately referred to as a floating facility 50. In addition, for example, a substation 60 is provided on the land.

In addition, the floating facilities 50 are connected by the dynamic cable 20 floating in the water. The floating facility 50 and the substation 60 are connected by the dynamic cable 20 and a subsea cable 30 buried in the seabed. The dynamic cable 20 and the subsea cable 30 are connected by a seabed joint 31.

Here, the dynamic cable 20 and the subsea cable 30 include a power transmission line (not illustrated) and an optical fiber 40 to be described later. Thus, power is transmitted between the floating facilities 50 and between the floating facility 50 and the substation 60 via the power transmission line, and communication is performed via the optical fiber 40. In general, a plurality of optical fibers 40 is included in the dynamic cable 20 and the subsea cable 30.

In each of the example embodiments described below, it is possible to monitor the dynamic cable 20 and the subsea cable 30 by executing optical fiber sensing using the optical fibers 40 included in the dynamic cable 20 and the subsea cable 30.

However, monitoring of the subsea cable 30 is not an essential part of the present disclosure. Therefore, in each of the example embodiments described below, the description of the monitoring of the subsea cable 30 will be omitted, and only the monitoring of the dynamic cable 20 will be described.

### First Example Embodiment

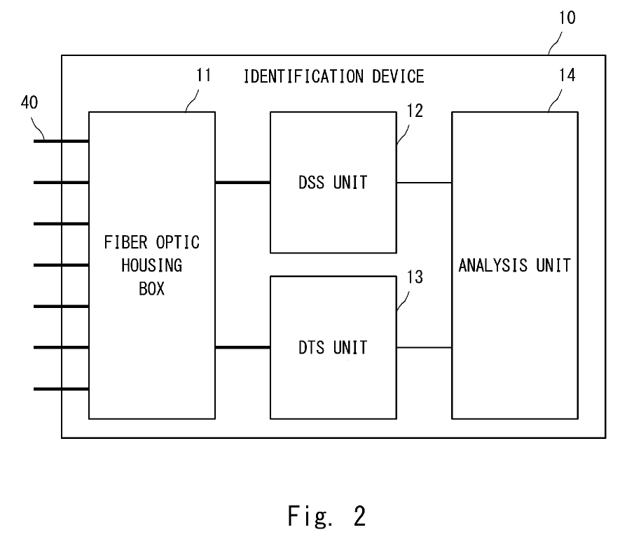

FIG. 2 is a diagram illustrating a schematic configuration example of an identification device 10 according to the present disclosure.

As illustrated in FIG. 2, the identification device 10 includes a fiber optic

housing box 11, a distributed strain sensing (DSS) unit 12, a distributed temperature sensing (DTS) unit 13, and an analysis unit 14. For example, the identification device 10 is installed inside the substation 60. However, the position of the identification device 10 to be installed is not limited to the position described above.

The fiber optic housing box 11 houses the optical fibers 40 included in the dynamic cable 20 and the subsea cable 30. FIG. 2 illustrates an example in which seven of the optical fibers 40 are included in the dynamic cable 20 and the subsea cable 30. Thus, the fiber optic housing box 11 houses the seven optical fibers 40.

The DSS unit 12 is connected to one of the optical fibers 40 housed in the fiber optic housing box 11, and executes DSS as optical fiber sensing using the connected optical fiber 40. The optical fiber 40 connected to the DSS unit 12 is preferably an unused optical fiber 40 that is not used for communication.

In executing the DSS, the DSS unit 12 outputs pulsed light to the optical fiber 40. As the pulsed light is transmitted through the optical fiber 40, backscattered light is generated in the optical fiber 40, and the DSS unit 12 receives the backscattered light.

Here, in a case where a distortion is generated in the dynamic cable 20, the characteristic (e.g. wavelength) of the backscattered light transmitted through the optical fiber 40 changes.

Thus, the DSS unit 12 can detect the distortion generated in the dynamic cable 20. The DSS unit 12 can calculate a magnitude of the distortion based on a degree of change in the characteristic of the backscattered light.

The DSS unit 12 can identify a position where the backscattered light is generated (a distance from the DSS unit 12) based on a time difference between a time at which pulsed light is output and a time at which backscattered light is received.

Thus, the DSS unit 12 can detect distortions of the positions on the dynamic cable 20 by executing the DSS.

The DTS unit 13 is connected to one of the optical fibers 40 housed in the fiber optic housing box 11, and executes DTS as optical fiber sensing using the connected optical fiber 40. The optical fiber 40 connected to the DTS unit 13 is preferably an unused optical fiber 40 that is not used for communication.

In executing the DTS, the DTS unit 13 outputs pulsed light to the optical fiber 40. As the pulsed light is transmitted through the optical fiber 40, backscattered light is generated in the optical fiber 40, and the DTS unit 13 receives the backscattered light.

Here, in a case where a temperature change occurs in the dynamic cable 20, the characteristic (e.g. wavelength) of the backscattered light transmitted through the optical fiber 40 changes.

Thus, the DTS unit 13 can detect the temperature change occurred in the dynamic cable 20. Furthermore, the DTS unit 13 can calculate a degree of the temperature change based on a degree of change in the characteristic of the backscattered light. Therefore, if an absolute value of a temperature in an initial status is set in advance, the DTS unit 13 can calculate a temperature from the temperature in the initial status and the degree of subsequent temperature change.

The DTS unit 13 can identify a position where the backscattered light is generated (a distance from the DTS unit 13) based on a time difference between a time at which pulsed light is output and a time at which backscattered light is received.

Therefore, the DTS unit 13 can detect temperatures at the positions on the dynamic cable 20 by executing the DTS.

Preferably, separate optical fibers 40 are connected to the DSS unit 12 and the DTS unit 13, and the DSS unit 12 and the DTS unit 13 simultaneously execute the DSS and the DTS, respectively.

The analysis unit 14 identifies a floating status of the dynamic cable 20 based on at least one of values of the distortions at the positions on the dynamic cable 20 detected by the DSS unit 12 and values of the temperatures at the positions on the dynamic cable 20 detected by the DTS unit 13.

Here, a specific example of the operation of the analysis unit 14 will be described.

(A) Specific Example A

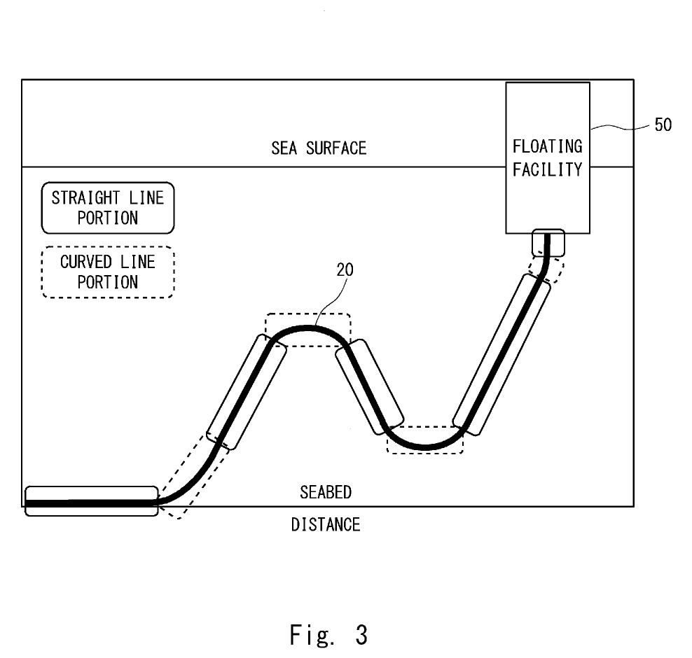

FIG. 3 is a diagram for explaining a specific example A of the operation of the analysis unit 14.

The specific example A is a specific example of an operation of identifying a floating status of the dynamic cable 20 based on values of distortions at positions on the dynamic cable 20 detected by the DSS unit 12.

As illustrated in FIG. 3, first, the analysis unit 14 calculates a bending radius of each of the positions based on the values of the distortions at the positions on the dynamic cable 20 detected by the DSS unit 12. Subsequently, the analysis unit 14 identifies whether each of the positions is a straight line portion having a linear shape or a curved line portion having a curved shape based on the value of the bending radius of each of the positions. For example, the analysis unit 14 may identify a position where a value of the bending radius is equal to or less than a threshold as a curved line portion.

As described above, in the specific example A, the analysis unit 14 identifies whether each of the positions on the dynamic cable 20 is a straight line portion or a curved line portion as the floating status of the dynamic cable 20.

(B) Specific Example B

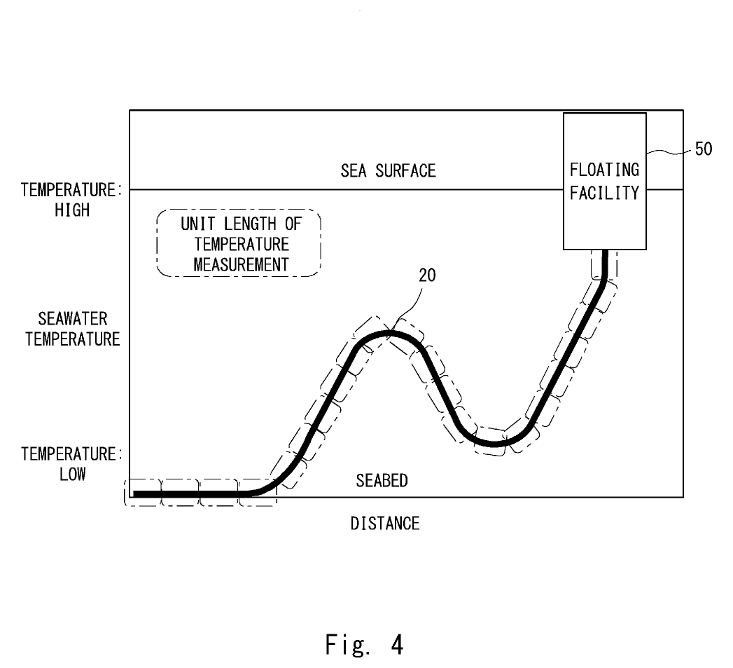

FIG. 4 is a diagram for explaining a specific example B of the operation of the analysis unit 14.

The specific example B is a specific example of an operation of identifying a floating status of the dynamic cable 20 based on values of temperatures at positions on the dynamic cable 20 detected by the DTS unit 13.

As illustrated in FIG. 4, a seawater temperature value is high at a position where a water depth is shallow, whereas the seawater temperature value is low at a position where the water depth is deep. Using this fact, the analysis unit 14 identifies water depths at positions based on the values of the temperatures at the positions on dynamic cable 20 detected by DTS unit 13. In the example of FIG. 4, temperatures related to the positions are detected and the water depths are identified for each unit length of the temperature measurement of the dynamic cable 20, but the present disclosure is not limited to this process.

As described above, in the specific example B, the analysis unit 14 identifies the water depths at the positions on the dynamic cable 20 as the floating status of the dynamic cable 20.

(C) Specific Example C

A specific example C is a specific example of the operation in which the specific example A of FIG. 3 and the specific example B of FIG. 4 are combined.

First, the analysis unit 14 identifies whether each of the positions on the dynamic cable 20 is a straight line portion or a curved line portion by the operation of the specific example A. Then, the analysis unit 14 identifies a water depth at each of the positions identified as the straight line portion and identifies a water depth at each of the positions identified as the curved line portion by the operation of the specific example B. As a result, it is possible to identify whether each of the positions on the dynamic cable 20 is a straight line portion or a curved line portion and to identify the water depth. Accordingly, it is possible to further improve the specific accuracy of the floating status of the dynamic cable 20.

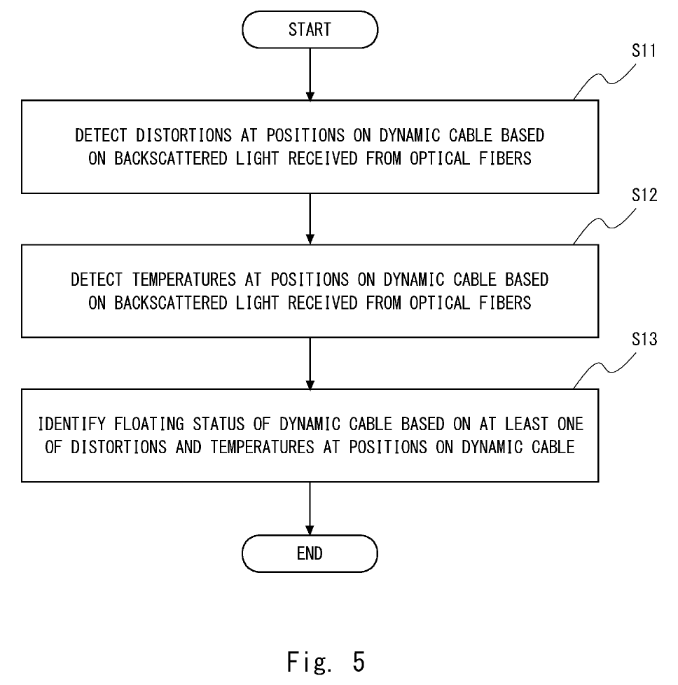

FIG. 5 is a flowchart for explaining an example of a schematic operation flow of the identification device 10 according to the present disclosure.

As illustrated in FIG. 5, the DSS unit 12 outputs pulsed light to the optical fibers 40 included in the dynamic cable 20 and the subsea cable 30, and receives backscattered light generated as the pulsed light is transmitted through the optical

fibers 40 from the optical fibers 40. Then, the DSS unit 12 detects distortions at positions on the dynamic cable 20 based on the backscattered light received from the optical fibers 40 (step S11).

The DTS unit 13 outputs pulsed light to the optical fibers 40 included in the dynamic cable 20 and the subsea cable 30, and receives backscattered light generated as the pulsed light is transmitted through the optical fibers 40 from the optical fibers 40. Then, the DTS unit 13 detects temperatures of positions on the dynamic cable 20 based on the backscattered light received from the optical fibers 40 (step S12).

It is preferable to simultaneously execute the processing of steps S11 and S12.

Thereafter, the analysis unit 14 identifies a floating status of the dynamic cable 20 based on at least one of values of the distortions at the positions on the dynamic cable 20 detected by the DSS unit 12 and values of the temperatures at the positions on the dynamic cable 20 detected by the DTS unit 13 (Step S13). In this case, the analysis unit 14 may identify the floating status of the dynamic cable 20 by, for example, any one of the operations of the specific examples A to C described above.

As described above, according to the present first example embodiment, the DSS unit 12 detects distortions at positions on the dynamic cable 20 based on the backscattered light received from the optical fibers 40. The DTS unit 13 detects temperatures of positions on the dynamic cable 20 based on the backscattered light received from the optical fibers 40. The analysis unit 14 identifies a floating status of the dynamic cable 20 based on at least one of values of the distortions at the positions on the dynamic cable 20 detected by the DSS unit 12 and values of the temperatures at the positions on the dynamic cable 20 detected by the DTS unit 13. As a result, it is possible to monitor the status of the dynamic cable 20 floating in the water.

Note that the identification device 10 according to the present disclosure includes the DSS unit 12 in order to detect distortions at positions on the dynamic

cable 20, but the present disclosure is not limited to this example. Specifically, a distortion detected by the DSS unit 12 is a static distortion. On the other hand, a distributed acoustic sensing (DAS) unit can also detect a dynamic distortion. Thus, the identification device 10 may include the DAS unit instead of the DSS unit 12 or in addition to the DSS unit 12. Then, the identification device 10 may detect distortions at positions on the dynamic cable 20 by at least one of the DSS unit 12 and the DAS unit.

In the identification device 10 according to the present disclosure, the analysis unit 14 identifies a floating status of the dynamic cable 20 based on at least one of values of the distortions at the positions and values of the temperatures at the positions on the dynamic cable 20, but the present disclosure is not limited to this example. The analysis unit 14 may process, per position on the dynamic cable 20, at least one of the distortions and the temperatures at the positions. Here, the processing refers to performing statistical processing or the like on at least one of the distortions and the temperatures. Then, the analysis unit 14 may identify the floating status of the dynamic cable 20 based on a value after processing at least one of the distortions and the temperatures at the positions on the dynamic cable 20.

### Second Example Embodiment

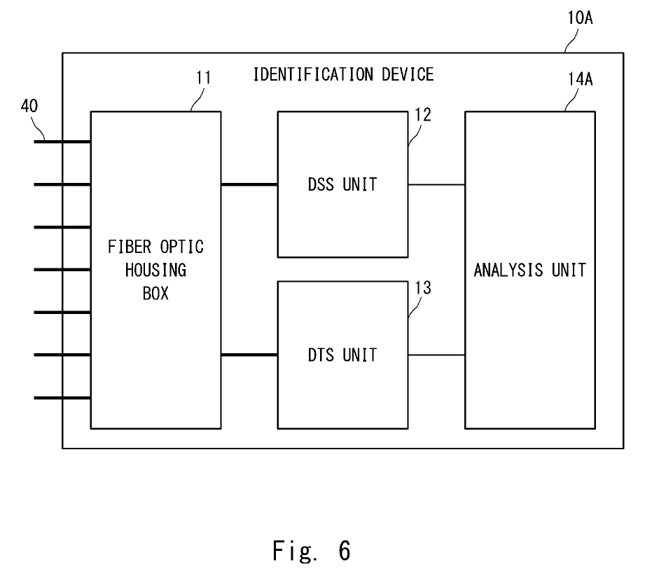

FIG. 6 is a diagram illustrating a schematic configuration example of an identification device 10A according to the present disclosure.

As illustrated in FIG. 6, the identification device 10A is different from the identification device 10 illustrated in FIG. 2 in that the analysis unit 14 is replaced with an analysis unit 14A.

The analysis unit 14A is different from the analysis unit 14 illustrated in FIG. 2 in that an operation of determining whether an abnormality has occurred in the dynamic cable 20 and an operation of estimating a life of the dynamic cable 20 are additionally performed.

Here, specific examples of additional operations among the operations of the analysis unit 14A will be described.

### Specific Example D

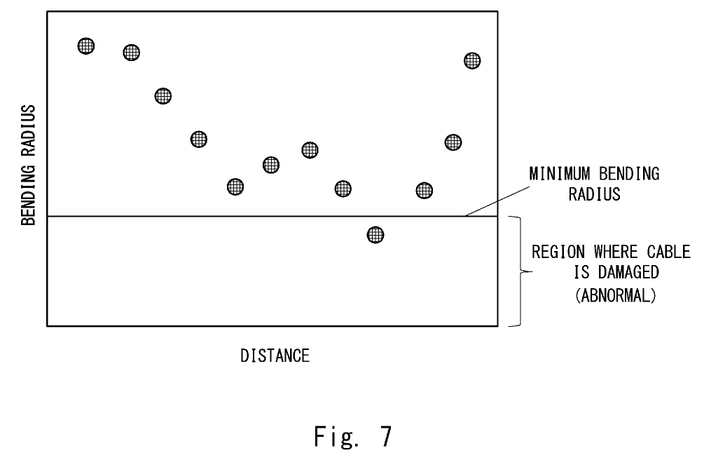

FIG. 7 is a diagram for explaining a specific example D of the operation of the analysis unit 14A.

The specific example D is a specific example of an operation of determining whether an abnormality has occurred in the dynamic cable 20 based on values of distortions at positions on the dynamic cable 20 detected by the DSS unit 12. In the specific example D, it is assumed that the analysis unit 14A holds, in advance, specification information including the minimum bending radius of the dynamic cable 20 and the like.

As illustrated in FIG. 7, first, the analysis unit 14A calculates a bending radius of each of the positions based on the values of the distortions at the positions on the dynamic cable 20 detected by the DSS unit 12. Subsequently, the analysis unit 14A compares a value of the bending radius at each of the positions with a value of the minimum bending radius of the dynamic cable 20. Then, the analysis unit 14A determines that an abnormality such as damage has occurred in the dynamic cable 20 at a position where the bending radius is equal to or less than the minimum bending radius among the positions on the dynamic cable 20.

### Specific Example E

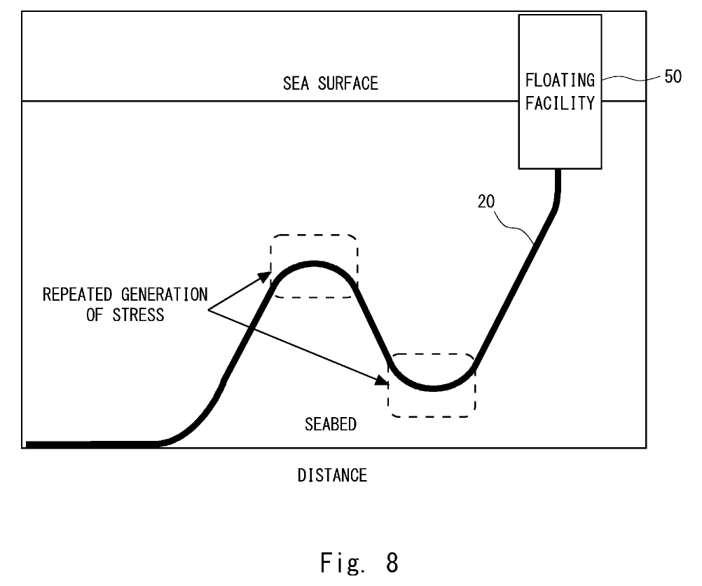

FIG. 8 is a diagram for explaining a specific example E of the operation of the analysis unit 14A.

The specific example E is a specific example of an operation of estimating a life of the dynamic cable 20 based on values of distortions at positions on the dynamic cable 20 detected by the DSS unit 12. In the specific example E, it is assumed that the analysis unit 14A holds, in advance, specification information including a fatigue limit of the dynamic cable 20 and the like.

As illustrated in FIG. 8, first, the analysis unit 14A identifies a position to be a curved line portion in the dynamic cable 20 based on values of distortions at positions on the dynamic cable 20 detected by the DSS unit 12. The method of identifying the curved line portion may be similar to the method of the specific example A described above. Next, the analysis unit 14A determines whether a

stress is repeatedly generated at a position identified as the curved line portion based on the value of the distortion at the position, calculates a value of the stress if the stress is repeatedly generated, and determines whether the value of the stress is equal to or more than a fatigue limit of the dynamic cable 20. In the example of FIG. 8, the stress equal to or more than the fatigue limit is repeatedly generated at two curved line portions of the dynamic cable 20. Then, the analysis unit 14A counts a number of occurrences of the stress at a position of the curved line portion where the stress equal to or more than the fatigue limit is repeatedly generated on the dynamic cable 20. Then, the analysis unit 14A estimates a remaining life of the dynamic cable 20 based on the value of the stress and the number of occurrences.

As described above, according to the present second example embodiment, the analysis unit 14A determines whether an abnormality has occurred in the dynamic cable 20 and estimates the life of the dynamic cable 20 based on values of distortions at positions on the dynamic cable 20 detected by the DSS unit 12. As a result, the status of the dynamic cable 20 floating in the water can be monitored in more detail as compared with the first example embodiment described above.

Similarly to the identification device 10, the identification device 10A according to the present disclosure may include the DAS unit instead of the DSS unit 12 or in addition to the DSS unit 12. Then, the identification device 10A may detect distortions at positions on the dynamic cable 20 by at least one of the DSS unit 12 and the DAS unit.

In the identification device 10A according to the present disclosure, the analysis unit 14A determines whether an abnormality has occurred in the dynamic cable 20 based on values of distortions at positions on the dynamic cable 20 and estimates the life of the dynamic cable 20, but the present disclosure is not limited to this example. The analysis unit 14A may process, per position on the dynamic cable 20, a distortion at the position. The processing method is similar to the method of the analysis unit 14. Then, the analysis unit 14A may determine whether an abnormality has occurred in the dynamic cable 20 and estimate the life

of the dynamic cable 20 based on a value after processing the distortions at the positions on the dynamic cable 20.

### Third Example Embodiment

The present third example embodiment is associated with an example embodiment that generalizes the first and second example embodiments described above.

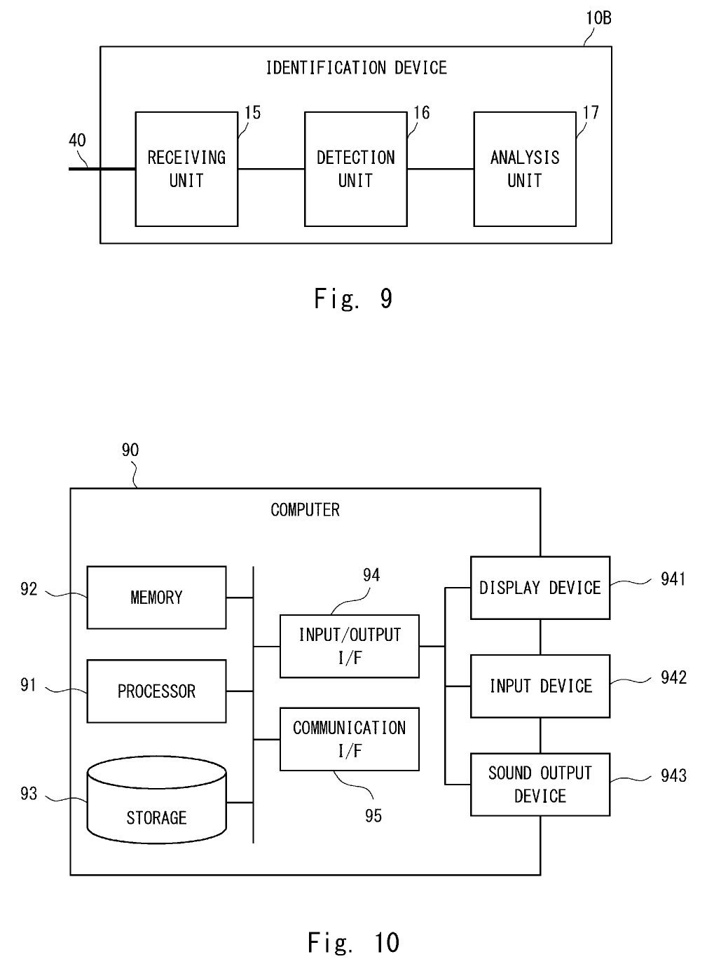

FIG. 9 is a diagram illustrating a schematic configuration example of an identification device 10B according to the present disclosure.

As illustrated in FIG. 9, the identification device 10B includes a receiving unit 15, a detection unit 16, and an analysis unit 17.

The receiving unit 15 receives backscattered light from the optical fibers 40 included in the floating cable (e.g. the dynamic cable 20).

Based on the backscattered light, the detection unit 16 detects distortions at positions on the cable and detects temperatures at positions on the cable. The detection unit 16 may implement a function of detecting the distortions at the positions on the cable by at least one of the DSS unit and the DAS unit. In addition, the detection unit 16 may implement a function of detecting the temperatures at the positions on the cable by the DTS unit.

The analysis unit 17 identifies a floating status of the cable based on at least one of the values of the distortions at the positions on the cable and the values of the temperatures at the positions on the cable.

As a result, it is possible to monitor the status of the floating cable.

The analysis unit 17 may identify whether each of the positions on the cable is a straight line portion or a curved line portion as the floating status of the cable based on the values of the distortions at the positions on the cable.

The analysis unit 17 may identify a water depth at each of the positions on the cable as the floating status of the cable based on the values of the temperatures at the positions on the cable.

In addition, the analysis unit 17 may calculate a bending radius at each of the positions on the cable based on the values of the distortions at the positions on the cable, and determine that an abnormality has occurred in the cable at a position where a value of the bending radius is equal to or less than a minimum bending radius of the cable among the positions on the cable.

In addition, the analysis unit 17 may calculate a stress repeatedly generated at a position to be the curved line portion on the cable based on the values of the distortions at the positions on the cable, count a number of occurrences of the stress in a case where a value of the stress is equal to or more than a fatigue limit of the cable, and estimate a remaining life of the cable based on the value of the stress and the number of occurrences.

### Hardware Configuration of Identification Device

FIG. 10 is a block diagram illustrating a schematic hardware configuration example of a computer 90 that implements the identification devices 10,10A, and 10B according to the present disclosure.

As illustrated in FIG. 10, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected to each other by a data transmission line for transmitting and receiving data.

The processor 91 is an arithmetic processing device such as a central processing unit (CPU) or a graphics processing unit (GPU). The memory 92 is a memory such as a random access memory (RAM) or a read only memory (ROM). The storage 93 is a storage device such as a hard disk drive (HDD), a solid state drive (SSD), or a memory card. The storage 93 may be a memory such as a RAM or a ROM.

A program is stored in the storage 93. This program includes instructions (or software code) for causing the computer 90 to perform one or more functions of the identification devices 10, 10A, and 10B described above in a case where the program is read by the computer. The components in the identification devices 10,10A, and 10B described above may be implemented by the processor 91 reading and executing a program stored in the storage 93. The storage function in the identification devices 10,10A, and 10B described above may be implemented by the memory 92 or the storage 93.

Further, the above-described program may be stored in a non-transitory computer-readable medium or a tangible storage medium. As an example and not by way of limitation, the computer-readable medium or the tangible storage medium includes a RAM, a ROM, a flash memory, an SSD or another memory technology, a compact disc (CD)-ROM, a digital versatile disc (DVD), a Blu-ray (registered trademark) disk or another optical disk storage, a magnetic cassette, a magnetic tape, a magnetic disk storage, or another magnetic storage device. The program may be transmitted on a transitory computer-readable medium or a communication medium. As an example and not by way of limitation, the transitory computer-readable medium or the communication medium includes an electrical signal, an optical signal, an acoustic signal, or another form of propagation signal.

The input/output interface 94 is connected to a display device 941, an input device 942, a sound output device 943, or the like. The display device 941 is a device that displays a screen associated with drawing data processed by the processor 91, such as a liquid crystal display (LCD), a cathode ray tube (CRT) display, or a monitor. The input device 942 is a device that receives an input of an operation performed by an operator, and is, for example, a keyboard, a mouse, or a touch sensor. The display device 941 and the input device 942 may be integrated, and may be implemented as a touch panel. The sound output device 943 is a device that acoustically outputs a sound associated with acoustic data processed by the processor 91, such as a speaker.

The communication interface 95 transmits and receives data to and from an external device. For example, the communication interface 95 communicates with the external device via a wired communication line or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### Supplementary Note 1

An identification device including:

at least one memory storing instructions; and

at least one processor configured to execute the instructions to:

receive backscattered light from an optical fiber included in a cable floating in the water;

detect distortions at each of positions on the cable and detect temperatures at each of the positions on the cable based on the backscattered light; and

identify a floating status of the cable based on at least one of values of the distortions at each of the positions on the cable and values of the temperatures at each of the positions on the cable.

### Supplementary Note 2

The identification device according to Supplementary Note 1, wherein

the at least one processor is configured to execute the instructions to identify whether each of the positions on the cable is a straight line portion or a curved line portion as the floating status of the cable based on the values of the distortions at each of the positions on the cable.

### Supplementary Note 3

The identification device according to Supplementary Note 2, wherein

the at least one processor is configured to execute the instructions to identify a water depth at each of the positions on the cable as the floating status of the cable based on the values of the temperatures at each of the positions on the cable.

### Supplementary Note 4

The identification device according to Supplementary Note 1, wherein

the at least one processor is configured to execute the instructions to:

calculate a bending radius at each of the positions on the cable based on the values of the distortions at each of the positions on the cable; and

determine that an abnormality has occurred in the cable at a position where a value of the bending radius is equal to or less than a minimum bending radius of the cable among the positions on the cable.

### Supplementary Note 5

The identification device according to Supplementary Note 2, wherein

the at least one processor is configured to execute the instructions to:

calculate a stress repeatedly generated at a position to be the curved line portion on the cable based on the values of the distortions at each of the positions on the cable;

count a number of occurrences of the stress in a case where a value of the stress is equal to or more than a fatigue limit of the cable; and

estimate a remaining life of the cable based on the value of the stress and the number of occurrences.

### Supplementary Note 6

An identification method executed by an identification device, the identification method including:

receiving backscattered light from an optical fiber included in a cable floating in the water;

detecting distortions at each of positions on the cable and detecting temperatures at each of the positions on the cable based on the backscattered light; and

identifying a floating status of the cable based on at least one of values of the distortions at each of the positions on the cable and values of the temperatures at each of the positions on the cable.

### Supplementary Note 7

A non-transitory computer-readable medium storing a program for causing a computer to execute:

a procedure of receiving backscattered light from an optical fiber included in a cable floating in the water;

a procedure of detecting distortions at each of positions on the cable and detecting temperatures at each of the positions on the cable based on the backscattered light; and

a procedure of identifying a floating status of the cable based on at least one of values of the distortions at each of the positions on the cable and values of the temperatures at each of the positions on the cable.

Note that, some or all of elements (e.g., structures and functions) specified in Supplementary Notes 2 to 5 dependent on Supplementary Note 1 may also be dependent on Supplementary Note 6 and Supplementary Note 7 in dependency similar to that of Supplementary Notes2 to 5 dependent on Supplementary Note 1. Some or all of elements specified in any of Supplementary Notes may be applied to various types of hardware, software, and recording means for recording software, systems, and methods.

What is claimed is:

1. An identification device comprising:
at least one memory storing instructions; and
at least one processor configured to execute the instructions to:
receive backscattered light from an optical fiber included in a cable floating in the water;
detect distortions at each of positions on the cable and detect temperatures at each of the positions on the cable based on the backscattered light; and
identify a floating status of the cable based on at least one of values of the distortions at each of the positions on the cable and values of the temperatures at each of the positions on the cable.

2. The identification device according to claim 1, wherein
the at least one processor is configured to execute the instructions to identify whether each of the positions on the cable is a straight line portion or a curved line portion as the floating status of the cable based on the values of the distortions at each of the positions on the cable.

3. The identification device according to claim 2, wherein
the at least one processor is configured to execute the instructions to identify a water depth at each of the positions on the cable as the floating status of the cable based on the values of the temperatures at each of the positions on the cable.

4. The identification device according to claim 1, wherein
the at least one processor is configured to execute the instructions to:
calculate a bending radius at each of the positions on the cable based on the values of the distortions at each of the positions on the cable; and
determine that an abnormality has occurred in the cable at a position where a value of the bending radius is equal to or less than a minimum bending radius of the cable among the positions on the cable.

5. The identification device according to claim 2, wherein
the at least one processor is configured to execute the instructions to:
calculate a stress repeatedly generated at a position to be the curved line portion on the cable based on the values of the distortions at each of the positions on the cable;
count a number of occurrences of the stress in a case where a value of the stress is equal to or more than a fatigue limit of the cable; and
estimate a remaining life of the cable based on the value of the stress and the number of occurrences.

6. An identification method executed by an identification device, the identification method comprising:
receiving backscattered light from an optical fiber included in a cable floating in the water;
detecting distortions at each of positions on the cable and detecting temperatures at each of the positions on the cable based on the backscattered light; and
identifying a floating status of the cable based on at least one of values of the distortions at each of the positions on the cable and values of the temperatures at each of the positions on the cable.

7. A non-transitory computer-readable medium storing a program for causing a computer to execute:
a procedure of receiving backscattered light from an optical fiber included in a cable floating in the water;
a procedure of detecting distortions at each of positions on the cable and detecting temperatures at each of the positions on the cable based on the backscattered light; and
a procedure of identifying a floating status of the cable based on at least one of values of the distortions at each of the positions on the cable and values of the temperatures at each of the positions on the cable.
